(19) United States
(12) Patent Application Publication
(10) Pub. No.: US 2021/0404070 A1
(43) Pub. Date: Dec. 30, 2021

(54) CATALYST-FREE ELECTROCHEMICAL DEUTERATION METHOD USING DEUTERIUM OXIDE AS DEUTERIUM SOURCE

(71) Applicants: NANJING UNIVERSITY, Jiangsu (CN); NANXIN PHARMACEUTICALS TECHNOLOGY RESEARCH INSTITUTE CO., LTD, Jiangsu (CN)

(72) Inventors: Xu Cheng, Jiangsu (CN); Xu Liu, Jiangsu (CN)

(21) Appl. No.: 17/281,625

(22) PCT Filed: Sep. 3, 2020
(86) PCT No.: PCT/CN2020/113159

§ 371 Date: Mar. 31, 2021

(30) Foreign Application Priority Data
Sep. 5, 2019 (CN) 201910837412.3

(51) Int. Cl. C25B 3/20; C25B 11/043; C25B 15/08; B01D 3/08; B01D 11/04; B01D 15/42; B01D 15/34; C25B 3/01; C25B 3/05; C25B 3/09; C25B 3/11; G01N 30/72

(52) U.S. Cl. CPC C25B 3/20; C25B 11/043; C25B 15/085; B01D 3/085; B01D 11/0492; G01N 30/7206; B01D 15/34; C25B 3/01; C25B 3/05; C25B 3/09; C25B 3/11; B01D 15/426

(57) ABSTRACT

A catalyst-free electrochemical deuteration method using deuterium oxide as a deuterium source, adding an electrolyte, an organic compound containing an ethylenic bond or acetylenic bond, deuterium oxide, and an organic solvent into a reactor, applying a direct current voltage of 4-8 V between electrodes of a carbon felt in an atmosphere of an inert gas for an electrolytic reaction, to obtain a product, and purifying the product to obtain a deuterated product. In the method provided by the present disclosure, with the organic compound containing an ethylenic bond or acetylenic bond as a raw material, deuterium oxide as a deuterium source, cheap and readily available carbon electrode materials as cathodes and anodes, it is possible to obtain deuterated products by a direct current electrolysis in an organic solvent, without any transition metal catalysts.

### CROSS REFERENCE TO RELATED APPLICATION

This application claims the priority of Chinese Patent Application No. 201910837412.3, entitled “Catalyst-free electrochemical deuteration method using deuterium oxide as deuterium source” filed with the China National Intellectual Property Administration on Sep. 5, 2019, which is incorporated herein by reference in its entirety.

### TECHNICAL FIELD

The present disclosure relates to a deuteration method using deuterium oxide as a deuterium source, and in particular to a catalyst-free electrochemical deuteration method using deuterium oxide as a deuterium source, belonging to the technical field of organic synthesis.

### BACKGROUND

Replacing carbon-hydrogen bonds with carbon-deuterium bonds in molecules can significantly improve the chemical stability of corresponding sites, and has a unique effect on the metabolism and efficacy of drugs. At present, the first deuterated drug Austedo has been approved by FDA in 2017, which is a milestone event in the field of drug synthesis. In addition, the introduction of deuterium atoms into the drugs already on the market can change the properties of the drugs in a minimum extent, and can be applied as a new drug. Due to this unique advantage, deuteration technology has gained extensive attention in recent two years.

Special deuterated reagents were needed in the prior deuteration technology, such as deuterated alcohol, deuterated dimethyl sulfoxide and deuterated acetonitrile, which is high costed and difficult to implement in a large scale. As the most basic source of deuterium, deuterium oxide is cheap and readily available, free of expensive secondary deuteration reagent, and is safe and environmentally friendly. It enables the maximum atom economy and step economy by using deuterium oxide as a deuterium source to deuterate organic molecules directly. However, in the prior art, the deuteration technology that uses deuterium oxide as a deuterium source to deuterate organic molecules directly mainly comprises the following steps: deuterium oxide is used as a reductant to generate a metal deuterium complexe in situ at the present of a catalyst-transition metals, and then the organic molecules are subjected to a deuteration reaction similar to a hydrogenation reaction. While, in the final stage of drug synthesis, it is necessary to avoid the use of transition metal catalysts, so as to avoid introducing highly toxic substances into the active ingredients of drugs. Therefore, there is an urgent need for a catalyst-free deuteration method using deuterium oxide as a deuterium source.

### SUMMARY

The objective of the present disclosure is to provide a catalyst-free electrochemical deuteration method using deuterium oxide as a deuterium source to overcome the shortcomings of the prior art. The method makes it possible to convert unsaturated bonds to anionic free radicals by means of cathodic reduction, and then the anionic free radicals react with deuterium oxide directly to generate carbon deuterium bonds, and the whole process is free from transition metals.

### Technical Solution

A catalyst-free electrochemical deuteration method using deuterium oxide as a deuterium source comprises steps:

adding an electrolyte, an organic compound containing an ethylenic bond or acetylenic bond, deuterium oxide, and an organic solvent into a reactor;

applying a direct current voltage of 4-8 V between electrodes of carbon felt in an atmosphere of an inert gas for an electrolytic reaction, to obtain a product; and

purifying the product to obtain a deuterated product;

wherein the organic compound containing an ethylenic bond or acetylenic bond is selected from the group consisting of olefin, alkyne, unsaturated ester, unsaturated amide and unsaturated carboxylic acid.

In some embodiments, the organic compound containing an ethylenic bond or acetylenic bond is selected from the group consisting of ethyl 3-phenylacrylate, butyl 3-phenylacrylate, 1-pentene-4-yl 3-phenylacrylate, cyclohexyl 3-phenylacrylate, tetrahydrofuran-3-yl 3-phenylacrylate, diethyl-phosphonomethyl 3-phenylacrylate, benzyl 3-phenylacrylate, phenyl 3-phenylacrylate, menthyl 3-phenylacrylate, 3-(3-phenylacrylyl) estrone, borneyl 3-phenylacrylate, pregnenolone 3-phenylacrylate, 3-(3-phenylacrylyl) estrone, and cholesteryl 3-phenylacrylate.

In some embodiments, the electrolyte is selected from the group consisting of tetrabutylammonium tetrafluoroborate and LiClO₄, and has a concentration of 0.02 mol/L.

In some embodiments, a molar ratio of deuterium oxide to the organic compound containing an ethylenic bond or acetylenic bond is in a range of (5-20): 1.

In some embodiments, the organic solvent is selected from the group consisting of DMF (N,N-Dimethylformamide) and acetonitrile.

In some embodiments, the inert gas is selected from the group consisting of nitrogen and argon.

In some embodiments, purifying the product comprises the following steps:

extracting the product with ethyl acetate to obtain an organic phase, washing the organic phase with saturated salt water, then drying with anhydrous sodium sulfate, and filtering to obtain a filtrate;

drying the filtrate with a rotary evaporator, to obtain a sample;

subjecting the sample to a column chromatography by using a column chromatography technology, in which 300-400 mesh silica gel is used as a stationary phase, and the sample is directly loaded on the silica gel, and eluted with a mixed solution of petroleum ether and ethyl acetate as an eluent, to obtain an eluate, which is detected by GC-MS;

collecting and concentrating the eluate containing a deuterated product.

The method provided by the present disclosure has the following beneficial effects:

In the method provided by the present disclosure, with the organic compound containing an ethylenic bond or acetylenic bond as a raw material, deuterium oxide as a deuterium source, cheap and readily available carbon electrode materials as cathodes and anodes, it is possible to obtain deuterated products by a direct current electrolysis in an organic solvent, without any transition metal catalysts. The method enables a yeild of 50-90%, and a deuterated ratio of not lower than 90%. Because of avoiding the use of transition metals, the reaction in the method is suitable for modifying drug molecules in the later stage. At the same time, since the method has a different reaction path from that of the transition metal-catalyzed reaction process, the method makes it possible to achieve a different chemical selectivity from that of the transition metal-catalyzed deuteration reaction process. Such deuteration reaction is applicable to electron-rich olefins, various heterocycles, compounds containing hydrogenation-sensitive protective groups such as benzyloxycarbonyl (Cbz), allyloxycarbonyl (Alloc). Such reaction could be conducted free of any acid and alkali additives and any auxiliary reagents, and has a conversion energy consumption of 200-500 mW/mmol.

### DETAILED DESCRIPTION

The present disclosure will be further illustrated with specific examples.

### Example 1

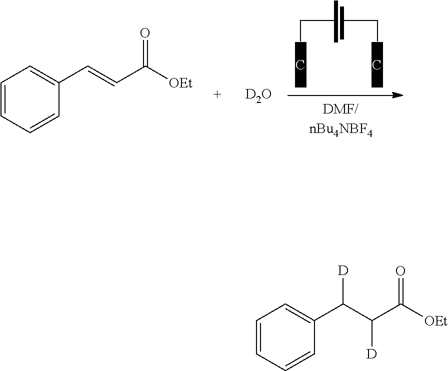

A catalyst-free electrochemical deuteration method using deuterium oxide as a deuterium source was provided, comprising

Tetrabutylammonium tetrafluoroborate (32.9 mg, 0.1 mmol) was added into a transparent two-neck reaction bottle with a capacity of 10 mL, one of the necks was plugged with a rubber stopper equipped with two electrodes, ethyl 3-phenylacrylate (35.2 mg, 0.2 mmol) and deuterium oxide (80.0 mg, 4 mmol) were added by a microsyringe, and then 5 mL of N,N-dimethylformamide was added, the resulting mixture was purged with nitrogen, and the reaction bottle was put on a magnetic stirrer; the electrodes were connected to a power supply, and a voltage of 6 V was applied between the electrodes, and the resulting mixture was stirred at 6 V for 2 h, to obtain a product; the product was extracted with ethyl acetate to obtain an organic phase, the organic phase was washed with saturated salt water, dried with anhydrous sodium sulfate, and then filtered to obtain a filtrate, and the filtrate was dried with a rotary evaporator to obtain a sample. The sample was subjected to a column chromatography by using a column chromatography technology, in which 300-400 mesh silica gel was used as a stationary phase and the sample was directly loaded on the silica gel, and eluted with a mixed solution of petroleum ether and ethyl acetate as an eluent, to obtain an eluate; the eluate was detected by GC-MS; the eluate containing a deuterated product was collected and concentrated to obtain 32.7 mg of a deuterated product 2a, i.e. ethyl 3-phenylpropionate, with a yield of 91%, a deuterated ratio of 99% for the benzyl position and 99% for the ortho position of carbonyl.

The data of NMR analysis of product 2a was as follows:

¹H NMR (400 MHz, Chloroform-d) δ 7.30-7.25 (m, 2H), 7.21-7.18 (m, 3H), 4.12 (q, J=7.2 Hz, 1H), 2.95-2.91 (m, 1.01H, 99% D), 2.62-2.58 (m, 1.01H, 99% D), 1.23 (t, J=7.1 Hz, 1H);

¹³C NMR (100 MHz, CDCl₃) δ 172.9, 140.5, 128.5, 128.3, 126.2, 60.4, 35.6 (t, J=20.0 Hz), 30.6 (t, J=20.0 Hz), 14.2.

### Example 2

A synthesis of

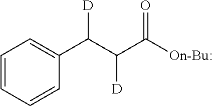

This example was performed as described in Example 1, except that n-butyl 3-phenylacrylate was used as the organic compound containing an ethylenic bond or acetylenic bond, obtaining the final deuterated product 2b, i.e. n-butyl 3-phenylpropionate, with a yield of 89%, and a deuterated ratio of 99% for the benzyl position and 98% for the ortho position of carbonyl.

The data of NMR analysis of product 2b was as follows:

¹H NMR (400 MHz, Chloroform-d) δ 7.30-7.26 (m, 2H), 7.21-7.17 (m, 3H), 4.07 (t, J=6.7 Hz, 2H), 2.95-2.91 (m, 1.03H, 97% D), 2.62-2.59 (m, 1.04H, 96% D), 1.61-1.54 (m, 2H), 1.38-1.28 (m, 2H), 0.91 (t, J=7.4 Hz, 3H);

¹³C NMR (100 MHz, CDCl₃) δ 173.0, 140.5, 128.5, 128.3, 126.2, 64.3, 35.6 (t, J=20.0 Hz), 30.7, 30.6 (t, J=20.0 Hz), 19.1, 13.7.

### Example 3

A synthesis of

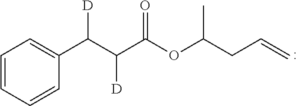 [SMILES: [2H]C(C(=O)OC(C)CC=C)C([2H])c1ccccc1]

This example was performed as described in Example 1, except that 1-pentene-4-yl 3-phenylacrylate was used as the organic compound containing an ethylenic bond or acetylenic bond, obtaining the final deuterated product 2c, i.e. 1-pentene-4-yl 3-phenylpropionate, with a yield of 86%, and a deuterated ratio of 97% for the benzyl position and 98% for the ortho position of carbonyl.

The data of NMR analysis of product 2c was as follows:

¹H NMR (400 MHz, Chloroform-d) δ 7.30-7.25 (m, 2H), 7.21-7.17 (m, 3H), 5.75-5.65 (m, 1H), 5.06 (d, J=8.3 Hz, 1H), 5.03 (s, 1H), 5.00-4.92 (m, 1H), 2.94-2.91 (m, 1.03H, 97% D), 2.60-2.56 (m, 1.02H, 98% D), 2.27 (qt, J=14.1, 6.6 Hz, 2H), 1.18 (d, J=6.3 Hz, 3H);

¹³C NMR (100 MHz, CDCl₃) δ 172.4, 140.5, 133.7, 128.4, 128.3, 126.2, 117.6, 70.1, 40.2, 35.8 (t, J=20.0 Hz), 30.7 (t, J=20.0 Hz), 19.4.

### Example 4

A synthesis of

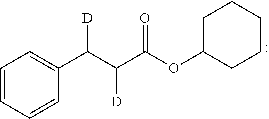 [SMILES: [2H]C(C(=O)OC1CCCCC1)C([2H])c1ccccc1]

This example was performed as described in Example 1, except that cyclohexyl 3-phenylacrylate was used as the organic compound containing an ethylenic bond or acetylenic bond, obtaining the final deuterated product 2d, i.e. cyclohexyl 3-phenylpropionate, with a yield of 80%, and a deuterated ratio of 97% for the benzyl position and 96% for the ortho position of carbonyl.

The data of NMR analysis of product 2d was as follows:

¹H NMR (400 MHz, Chloroform-d) δ 7.30-7.25 (m, 2H), 7.21-7.17 (m, 3H), 4.75 (dt, J=9.0, 4.7 Hz, 1H), 2.95-2.91 (m, 1.03H, 97% D), 2.61-2.57 (m, 1.04H, 96% D), 1.81-1.75 (m, 2H), 1.72-1.67 (m, 2H), 1.56-1.49 (m, 1H), 1.42-1.22 (m, 5H);

¹³C NMR (100 MHz, CDCl₃) δ 172.4, 140.6, 128.4, 128.3, 126.2, 72.6, 35.9 (t, J=20.0 Hz), 31.6, 30.7 (t, J=20.0 Hz), 25.4, 23.7.

### Example 5

A synthesis of

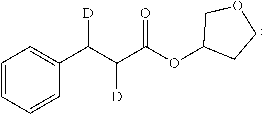 [SMILES: [2H]C(C(=O)OC1CCOC1)C([2H])c1ccccc1]

This example was performed as described in Example 1, except that tetrahydrofuran-3-yl 3-phenyl-2-acrylate was used as the organic compound containing an ethylenic bond or acetylenic bond, obtaining the final deuterated product 2e, i.e. tetrahydrofuran-3-yl 3-phenylpropionate, with a yield of 88%, and a deuterated ratio of 98% for the benzyl position and 95% for the ortho position carbonyl.

The data of NMR analysis of product 2e was as follows:

¹H NMR (400 MHz, Chloroform-d) δ 7.30-7.25 (m, 2H), 7.22-7.18 (m, 3H), 5.29-5.26 (m, 1H), 3.88-3.80 (m, 3H), 3.75 (d, J=10.5 Hz, 1H), 2.94-2.91 (m, 1.02H, 98% D), 2.64-2.60 (m, 1.05H, 95% D), 2.17-2.08 (m, 1H), 1.94-1.88 (m, 1H);

¹³C NMR (100 MHz, CDCl₃) δ 172.7, 140.2, 128.5, 128.3, 126.3, 74.8, 73.1, 67.0, 35.5 (t, J=20.0 Hz), 32.7, 30.5 (t, J=20.0 Hz).

### Example 6

A synthesis of

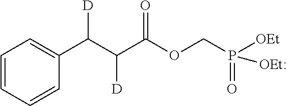

This example was performed as described in Example 1, except that diethyl-phosphonomethyl 3-phenylacrylate was used as the organic compound containing an ethylenic bond or acetylenic bond, obtaining the final deuterated product 2f, i.e. diethyl-phosphonomethyl 3-phenylpropionate, with a yield of 68%, and a deuterated ratio of 96% for the benzyl position and 910% for the ortho position of carbonyl.

The data of NMR analysis of product 2f was as follows:

¹H NMR (400 MHz, Chloroform-d) δ 7.31-7.27 (m, 2H), 7.21-7.19 (m, 3H), 4.39 (s, 1H), 4.36 (s, 1H), 4.15 (p, J=8.0, 7.5 Hz, 4H), 2.98-2.94 (m, 1.04H, 96% D), 2.73-2.69 (m, 1.04H, 96% D), 1.33 (t, J=7.1 Hz, 3H);

¹³C NMR (100 MHz, Chloroform-d) δ 171.9 (d, J=7.6 Hz), 140.0, 128.5, 128.3, 126.4, 62.8 (d, J=6.2 Hz), 56.9 (d, J=169.4 Hz), 35.1 (t, J=20.0 Hz), 30.4 (t, J=20.0 Hz), 16.4 (d, J=5.8 Hz).

### Example 7

A synthesis of

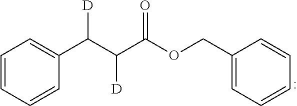 [SMILES: [2H]C(C(=O)OCc1ccccc1)C([2H])c1ccccc1]

This example was performed as described in Example 1, except that benzyl 3-phenylacrylate was used as the organic compound containing an ethylenic bond or acetylenic bond, obtaining the final deuterated product 2g, i.e. benzyl 3-phenylpropionate, with a yield of 77%, and a deuterated ratio of 96% for the benzyl position and 91% for the ortho position of carbonyl.

The data of NMR analysis of product 2g was as follows:

¹H NMR (400 MHz, Chloroform-d) δ 7.36-7.25 (m, 7H), 7.21-7.17 (m, 3H), 5.10 (s, 2H), 2.97-2.93 (m, 1.04H, 96% D), 2.68-2.64 (m, 1.09H, 91% D;

¹³C NMR (100 MHz, CDCl₃) δ 172.7, 140.4, 136.0, 128.6, 128.5, 128.3, 128.2, 126.3, 66.3, 35.6 (t, J=20.0 Hz), 30.6 (t, J=20.0 Hz).

### Example 8

A synthesis of

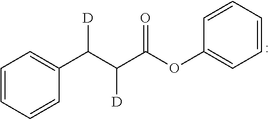 [SMILES: [2H]C(C(=O)Oc1ccccc1)C([2H])c1ccccc1]

This example was performed as described in Example 1, except that phenyl 3-phenylacrylate was used as the organic compound containing an ethylenic bond or acetylenic bond, obtaining the final deuterated product 2h, i.e. phenyl 3-phenylpropionate, with a yield of 82%, and a deuterated ratio of 99% for the benzyl position and 94% for the ortho position of carbonyl.

The data of NMR analysis of product 2h was as follows:

¹H NMR (400 MHz, Chloroform-d) δ 7.37-7.30 (m, 4H), 7.27-7.19 (m, 4H), 7.00 (d, J=7.8 Hz, 2H), 3.08-3.04 (m, 1.01H, 99% D), 2.88-2.85 (m, 1.06H, 94% D);

¹³C NMR (100 MHz, CDCl₃) δ 171.4, 150.7, 140.1, 129.4, 128.6, 128.4, 126.5, 125.8, 121.6, 35.7 (t, J=20.0 Hz), 30.61 (t, J=20.0 Hz).

### Example 9

A synthesis of

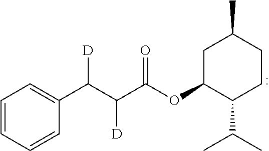 [SMILES: [2H]C(C(=O)O[C@H]1C[C@@H](C)CC[C@@H]1C(C)C)C([2H])c1ccccc1]

This example was performed as described in Example 1, except that menthyl 3-phenylacrylate was used as the the organic compound containing an ethylenic bond or acetylenic bond, obtaining the final deuterated product 2i, i.e. menthyl 3-phenylpropionate, with a yield of 73%, and a deuterated ratio of 99% for the benzyl position and 94% for the ortho position of carbonyl.

The data of NMR analysis of product 2i was as follows:

¹H NMR (400 MHz, Chloroform-d) δ 7.29-7.25 (m, 2H), 7.20-7.17 (m, 3H), 4.67 (td, J=10.9, 4.4 Hz, 1H), 2.94-2.90 (m, 1.01H, 99% D), 2.61-2.57 (m, 1.06H, 94% D), 1.93 (d, J=12.0 Hz, 1H), 1.76-1.64 (m, 3H), 1.52-1.40 (m, 3H), 1.36-1.29 (m, 1H), 1.08-0.98 (m, 1H), 0.96-0.83 (m, 8H), 0.70 (d, J=6.9 Hz, 3H);

¹³C NMR (100 MHz, CDCl₃) δ 172.5, 140.5, 128.4, 128.3, 126.2, 74.2, 47.0, 40.9, 35.8 (t, J=20.0 Hz), 34.3, 31.4, 30.7 (t, J=20.0 Hz), 26.2, 23.4, 22.0, 20.8, 16.3.

### Example 10

A synthesis of

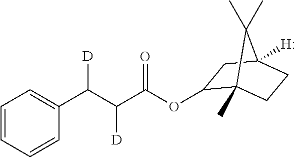

This example was performed as described in Example 1, except that borneyl 3-phenylacrylate was used as the organic compound containing an ethylenic bond or acetylenic bond, obtaining the final deuterated product 2j, i.e. borneyl 3-phenylpropioinate-2,3-D2, with a yield of 86%, and a deuterated ratio of 93% for the benzyl position and 97% for the ortho position of carbonyl.

The data of NMR analysis of product 2j was as follows:

¹H NMR (400 MHz, Chloroform-d) δ 7.34-7.30 (m, 2H), 7.26-7.21 (m, 3H), 4.90 (dt, J=9.9, 2.8 Hz, 1H), 2.98-2.93 (m, 1.07H, 93% D), 2.69-2.66 (m, 1.03H, 97% D), 2.39-2.32 (m, 1H), 1.94-1.88 (m, 1H), 1.79-1.71 (m, 2H), 1.69-1.67 (m, 1H), 1.33-1.17 (m, 2H), 0.92 (s, 3H), 0.89 (s, 3H), 0.81 (s, 3H);

¹³C NMR (100 MHz, CDCl₃) δ 173.3, 140.5, 128.5, 128.3, 126.2, 79.9, 48.7, 47.8, 44.9, 36.7, 35.8 (t, J=20.0 Hz), 30.7 (t, J=20.0 Hz), 28.0, 27.1, 19.7, 18.9, 13.5.

### Example 11

A synthesis of

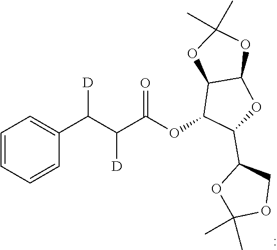 [SMILES: [2H]C(C(=O)O[C@@H]1[C@H]2OC(C)(C)O[C@H]2O[C@@H]1[C@H]1COC(C)(C)O1)C([2H])c1ccccc1]

This example was performed as described in Example 1, except that (3aR,5S,6S,6aR)-5-((R)-2,2-dimethyl-1,3-dioxolan-4-yl)-2,2-dimethyltetrah ydrofuro[2,3-d][1,3]dioxol-6-yl 3-phenylacrylate was used as the organic compound containing an ethylenic bond or acetylenic bond, obtaining the final deuterated product 2k, i.e. (3aR,5S,6S,6aR)-5-((R)-2,2-dimethyl-1,3-dioxolan-4-yl)-2,2-dimethyltetrah ydrofuro[2,3-d][1,3]dioxol-6-yl 3-phenylpropionate, with a yield of 62%, and a deuterated ratio of 97% for the benzyl position and 95% for the ortho position of carbonyl.

The data of NMR analysis of product 2k was as follows:

¹H NMR (400 MHz, Chloroform-d) δ 7.30 (t, J=7.2 Hz, 2H), 7.24-7.19 (m, 3H), 5.73 (d, J=3.6 Hz, 1H), 5.22 (d, J=2.3 Hz, 1H), 4.25 (d, J=3.9 Hz, 1H), 4.20-4.14 (m, 2H), 4.06-3.98 (m, 2H), 2.96-2.93 (m, 1.03H, 97% D), 2.69-2.64 (m, 1.05H, 95% D), 1.50 (s, 3H), 1.40 (s, 3H), 1.31 (s, 3H), 1.27 (s, 3H);

¹³C NMR (100 MHz, CDCl₃) δ 171.5, 139.9, 128.5, 128.4, 126.5, 112.2, 109.3, 105.0, 83.2, 79.7, 76.1, 72.4, 67.2, 35.4 (t, J=20.0 Hz), 30.6 (t, J=20.0 Hz), 26.9, 26.7, 26.2, 25.3.

### Example 12

A synthesis of

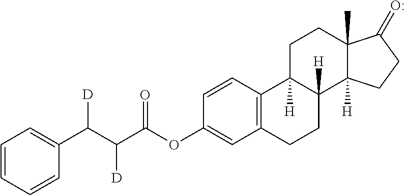

This example was performed as described in Example 1, except that 3-(3-phenylacrylyl) estrone was used as the organic compound containing an ethylenic bond or acetylenic bond, obtaining the final deuterated product 21, i.e. 3-(3-phenylpropionate) estrone, with a yield of 52%, and a deuterated ratio of 97% for the benzyl position and 96% for the ortho position of carbonyl.

The data of NMR analysis of product 21 was as follows:

¹H NMR (400 MHz, Chloroform-d) δ 7.34-7.30 (m, 2H), 7.27-7.22 (m, 4H), 6.78 (dd, J=8.5, 2.4 Hz, 1H), 6.74 (s, 1H), 3.07-3.04 (m, 1.03H, 97% D), 2.89 (dd, J=9.5, 4.8 Hz, 2H), 2.85-2.83 (m, 1.04H, 96% D), 2.51 (dd, J=18.8, 8.6 Hz, 1H), 2.42-2.37 (m, 1H), 2.31-2.24 (m, 1H), 2.19-1.94 (m, 4H), 1.65-1.41 (m, 6H), 0.90 (s, 3H);

¹³C NMR (100 MHz, CDCl₃) δ 171.7, 148.5, 140.1, 138.0, 137.4, 128.6, 128.4, 126.4, 126.4, 121.6, 118.7, 50.5, 48.0, 44.2, 38.0, 36.0, 35.7 (t, J=20.0 Hz), 31.6, 30.6 (t, J=20.0 Hz), 29.4, 26.4, 25.8, 21.6, 13.8.

### Example 13

A synthesis of

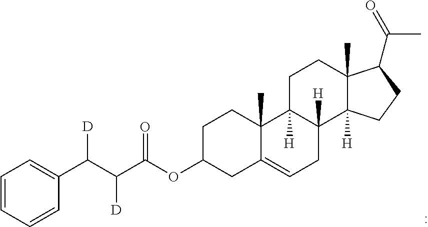

This example was performed as described in Example 1, except that pregnenolone 3-phenylacrylate was used as the organic compound containing an ethylenic bond or acetylenic bond, obtaining the final deuterated product 2m, i.e. pregnenolone 3-phenylpropionate, with a yield of 57%, and a deuterated ratio of 98% for the benzyl position and 96% for the ortho position of ester carbonyl.

The data of NMR analysis of product 2m was as follows:

¹H NMR (400 MHz, Chloroform-d) δ 7.31-7.26 (m, 2H), 7.20 (dd, J=7.3, 5.5 Hz, 3H), 5.37 (d, J=4.6 Hz, 1H), 4.65-4.57 (m, 1H), 2.95-2.91 (m, 1.02H, 98% D), 2.61-2.57 (m, 1.04H, 96% D), 2.54 (t, J=9.0 Hz, 1H), 2.28 (d, J=7.4 Hz, 2H), 2.22-2.17 (m, 1H), 2.13 (s, 3H), 2.06-1.97 (m, 2H), 1.89-1.81 (m, 2H), 1.68-1.44 (m, 8H), 1.29-1.10 (m, 4H), 1.01 (s, 3H), 0.63 (s, 3H);

¹³C NMR (100 MHz, CDCl₃) δ 209.6, 172.4, 140.5, 139.7, 128.5, 128.3, 126.2, 122.3, 73.9, 63.7, 56.8, 49.9, 44.0, 38.8, 38.0, 37.0, 36.6, 35.9 (t, J=20.0 Hz), 31.8, 31.8, 31.6, 30.7 (t, J=20.0 Hz), 27.7, 24.5, 22.8, 21.0, 19.3, 13.2.

### Example 14

A synthesis of

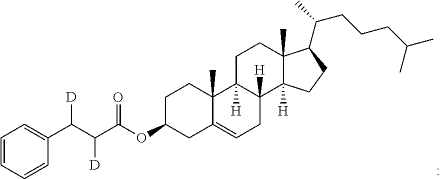

This example was performed as described in Example 1, except that cholesteryl 3-phenylacrylate was used as the organic compound containing an ethylenic bond or acetylenic bond, obtaining the final deuterated product 2n, i.e. cholesteryl 3-phenylpropionate, with a yield of 45%, and a deuterated ratio of 99% for the benzyl position and 94% for the ortho position of carbonyl.

The data of NMR analysis of product 2n was as follows:

¹H NMR (400 MHz, Chloroform-d) δ 7.30-7.26 (m, 2H), 7.21-7.18 (m, 3H), 5.36 (d, J=5.0 Hz, 1H), 4.65-4.57 (m, 1H), 2.95-2.91 (m, 1.01H, 99% D), 2.60-2.56 (m, 1.06H, 94% D), 2.28 (d, J=8.1 Hz, 2H), 2.04-1.76 (m, 6H), 1.57-1.08 (m, 20H), 1.01 (s, 3H), 0.91 (d, J=6.4 Hz, 3H), 0.87 (d, J=1.5 Hz, 3H), 0.86 (d, J=1.5 Hz, 3H), 0.67 (s, 3H);

¹³C NMR (100 MHz, CDCl₃) δ 172.3, 140.7, 139.7, 128.4, 128.3, 126.2, 122.6, 74.0, 56.7, 56.1, 50.0, 42.3, 39.7, 39.5, 38.1, 37.0, 36.6, 36.2, 35.9 (t, J=20.0 Hz), 35.8, 31.9, 31.9, 30.7 (t, J=20.0 Hz), 28.2, 28.0, 27.8, 24.3, 23.8, 22.8, 22.6, 21.0, 19.3, 18.7, 11.9.

### Example 15

A synthesis of

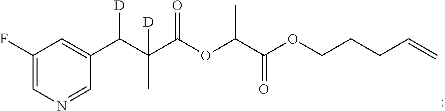 [SMILES: [2H]C(c1cncc(F)c1)C([2H])(C)C(=O)OC(C)C(=O)OCCCC=C]

This example was performed as described in Example 1, except that pent-4-en-1-yl(E) 2-[3-(5-fluoropyridin-3-yl)-2-methyl-acryloylamino]-propionate was used as the organic compound containing an ethylenic bond or acetylenic bond, obtaining the final deuterated product 2o, i.e. pent-4-en-1-yl(E) 2-[3-(5-fluoropyridin-3-yl)-2-methyl-propionamido-α,β-D2]-propionate, with a yield of 56%, and a deuterated ratio of 87% for the benzyl position and 80% for the ortho position of carbonyl.

The data of NMR analysis of product 20 was as follows:

¹H NMR (400 MHz, Chloroform-d) δ 8.32 (s, 1H), 8.25 (d, J=6.8 Hz, 1H), 7.25 (ddd, J=9.2, 4.6, 2.8 Hz, 1H), 6.08 (dd, J=29.5, 7.4 Hz, 1H), 5.84-5.73 (m, 1H), 5.06-4.99 (m, 2H), 4.53 (tt, J=7.2, 3.9 Hz, 1H), 4.56-4.49 (m, 2H), 3.03-2.99 (m, 0.57H), 2.68 (s, 0.56H), 2.53-2.46 (m, 0.20H, 80% D), 2.12 (q, J=7.3, 6.5 Hz, 2H), 1.77-1.70 (m, 2H), 1.37 (d, J=7.1 Hz, 1.51H), 1.26-1.20 (m, 4.52H);

¹³C NMR (100 MHz, Chloroform-d) δ 174.1 (d, J=16.2 Hz), 172.9 (d, J=7.0 Hz), 159.4 (dd, J=256.7, 4.7 Hz), 146.1 (d, J=3.8 Hz), 137.1 (d, J=4.3 Hz), 136.9 (dd, J=16.3, 3.7 Hz), 136.1 (d, J=23.1 Hz), 123.3 (dd, J=17.6, 4.0 Hz), 115.5 (d, J=2.7 Hz), 64.9, 47.9 (d, J=7.8 Hz), 42.2 (t, J=20.0 Hz), 36.0 (t, J=20.0 Hz), 29.8, 27.6, 18.5 (d, J=5.7 Hz), 17.6 (dd, J=14.0, 2.0 Hz); 19F NMVR (376 MHz, CDCl₃) δ −127.37.

### Example 16

A synthesis of

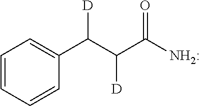

This example was performed as described in Example 1, except that cinnamide was used as the organic compound containing an ethylenic bond or acetylenic bond, obtaining the final deuterated product 2p, i.e. 3-phenylpropionamide-α,β-D2, with a yield of 67%, and a deuterated ratio of 94% for the benzyl position and 93% for the ortho position of carbonyl.

The data of NMR analysis of product 2p was as follows:

¹H NMR (400 MHz, Chloroform-d) δ 7.30-7.26 (m, 2H), 7.20 (dt, J=9.4, 3.1 Hz, 1H), 5.77 (s, 1H), 5.48 (s, 1H), 2.96-2.92 (m, 1.06H, 94% D), 2.52-2.48 (m, 1.07H, 93% D);

¹³C NMR (100 MHz, CDCl₃) δ 174.7, 140.6, 128.6, 128.3, 126.3, 37.1 (t, J=20.0 Hz), 31.0 (t, J=20.0 Hz).

### Example 17

A synthesis of

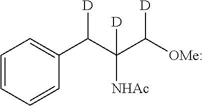

This example was performed as described in Example 1, except that methyl α-acetylaminocinnamate was used as the organic compound containing an ethylenic bond or acetylenic bond, obtaining the final deuterated product 2q, i.e. methyl 3-phenyl-2-acetylaminopropionate-α,β-D2, with a yield of 55%, and a deuterated ratio of 91% for the benzyl position and 90% for the ortho position of carbonyl.

The data of NMR analysis of product 2q was as follows:

¹H NMR (400 MHz, Chloroform-d) δ 7.32-7.25 (m, 3H), 7.09 (d, J=6.7 Hz, 2H), 5.89 (s, 1H), 4.90-4.87 (m, 0.10H, 90% D), 3.73 (s, 3H), 3.13-3.08 (m, 1.09H, 91% D), 1.99 (s, 3H);

¹³C NMR (100 MHz, CDCl₃) δ 172.1, 169.6, 135.8, 129.2, 128.6, 127.1, 52.8 (t, J=20.0 Hz), 52.3, 37.5 (t, J=20.0 Hz), 23.1.

### Example 18

A synthesis of

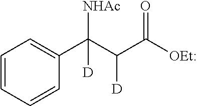

This example was performed as described in Example 1, except that ethyl β-acetylaminocinnamate was used as the organic compound containing an ethylenic bond or acetylenic bond, obtaining the final deuterated product 2r, i.e. ethyl 3-phenyl-3-acetylaminopropionate-α,β-D2, with a yield of 55%, and a deuterated ratio of 93% for the benzyl position and 94% for the ortho position of carbonyl.

The data of NMR analysis of product 2r was as follows:

¹H NMR (400 MHz, Chloroform-d) δ 7.35-7.26 (m, 5H), 6.76 (d, J=5.4 Hz, 1H), 5.44-5.41 (m, 0.07H, 93% D), 4.07 (q, J=7.2 Hz, 2H), 2.88-2.79 (m, 1.06H, 94% D), 2.00 (s, 3H), 1.17 (t, J=7.2 Hz, 3H);

¹³C NMR (100 MHz, CDCl₃) δ 171.2, 169.3, 140.5, 128.6, 127.6, 126.3, 60.7, 49.3 (t, J=20.0 Hz), 39.7 (t, J=20.0 Hz), 23.3, 14.0.

### Example 19

A synthesis of

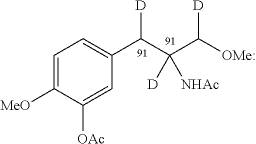

This example was performed as described in Example 1, except that ethyl α-acetylamino-3-(4-methoxyl-3-acetoxyl-phenyl)-acrylate was used as the organic compound containing an ethylenic bond or acetylenic bond, obtaining the final deuterated product 2s, i.e. ethyl α-acetylamino-3-(4-methoxyl-3-acetoxyl-phenyl)-propionate-α,β-D2, with a yield of 42%, and a deuterated ratio of 91% for the benzyl position and 91% for the ortho position of carbonyl.

The data of NMR analysis of product 2s was as follows:

¹H NMR (400 MHz, Chloroform-d) δ 6.93 (dd, J=8.4, 2.1 Hz, 1H), 6.88 (d, J=8.4 Hz, 1H), 6.78 (d, J=2.1 Hz, 1H), 6.13 (s, 1H), 4.85-4.81 (m, 0.09H, 91% D), 3.81 (s, 3H), 3.72 (s, 3H), 3.04-3.02 (m, 1.09H, 91% D), 2.30 (s, 3H), 1.98 (s, 3H);

¹³C NMR (100 MHz, CDCl₃) δ 172.0, 169.8, 169.0, 150.2, 139.5, 128.3, 127.3, 123.9, 112.5, 55.9, 52.8 (t, J=20.0 Hz), 52.3, 36.4 (t, J=20.0 Hz), 23.0, 20.6.

### Example 20

A synthesis of

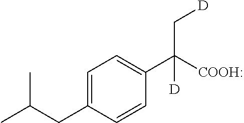

This example was performed as described in Example 1, except that 2-(4-isobutyl-phenyl)-acrylic acid was used as the organic compound containing an ethylenic bond or acetylenic bond, obtaining the final deuterated product 2t, i.e. 2-(4-isobutyl-phenyl)-propionic acid-α,β-D2, with a yield of 59%, and a deuterated ratio of 90% for the benzyl position and 90% for the ortho position of carbonyl.

The data of NMR analysis of product 2t was as follows:

¹H NMR (400 MHz, Chloroform-d) δ 7.26-7.21 (m, 2H), 7.11 (t, J=9.7 Hz, 2H), 3.71-3.68 (m, 0.10H, 90% D), 2.44 (d, J=7.2 Hz, 2H), 1.84 (dt, J=13.4, 6.6 Hz, 1H), 1.47 (s, 2.10H, 90% D), 0.89 (d, J=6.6 Hz, 6H);

¹³C NMR (100 MHz, CDCl₃) δ 180.5, 140.8, 137.0, 129.4, 127.3, 45.1, 44.5 (t, J=20.0 Hz), 30.2, 22.4, 17.8 (t, J=20.0 Hz).

### Example 21

A synthesis of

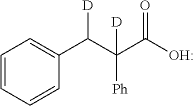

This example was performed as described in Example 1, except that α-phenylcinnamic acid was used as the organic compound containing an ethylenic bond or acetylenic bond, obtaining the final deuterated product 2u, i.e. 2,3-diphenylpropionate-α,β-D2, with a yield of 75%, and a deuterated ratio of 99% for the benzyl position and 94% for the ortho position of carbonyl.

The data of NMR analysis of product 2u was as follows:

¹H NMR (400 MHz, Chloroform-d) δ 7.30-7.15 (m, 8H), 7.09 (d, J=7.0 Hz, 2H), 3.86-3.82 (m, 0.06H, 94% D), 3.37 (s, 0.47H), 3.00 (s, 0.54H);

¹³C NMR (100 MHz, CDCl₃) δ 179.1, 138.7, 137.9, 128.9, 128.7, 128.4, 128.1, 127.6, 126.5, 53.0 (t, J=20.0 Hz), 38.9 (t, J=20.0 Hz).

### Example 22

A synthesis of

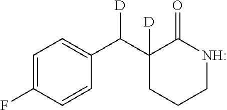

This example was performed as described in Example 1, except that (E)-3-(4-fluoro-phenyl-methylene)-piperidine-2-one was used as the organic compound containing an ethylenic bond or acetylenic bond, obtaining the final deuterated product 2v, i.e. 3-(4-fluoro-benzyl)-piperidine-2-one-α,β-D2, with a yield of 75%, and a deuterated ratio of 95% for the benzyl position and 91% for the ortho position of carbonyl.

The data of NMR analysis of product 2v was as follows:

¹H NMR (400 MHz, Chloroform-d) δ 7.16 (dd, J=8.6, 5.5 Hz, 2H), 6.97 (t, J=8.7 Hz, 2H), 6.11 (s, 1H), 3.33-3.22 (m, 2.53H), 2.68 (s, 0.52H), 2.53-2.48 (m, 0.09H, 91% D), 1.83-1.63 (m, 3H), 1.46-1.39 (m, 1H);

¹³C NMR (100 MHz, Chloroform-d) δ 173.9, 161.5 (d, J=244.1 Hz), 135.4, 130.6 (d, J=7.7 Hz), 115.1 (d, J=21.0 Hz), 42.5, 42.4 (t, J=20.0 Hz), 36.1 (t, J=20.0 Hz), 25.3, 21.3; 19F NMR (376 MHz, CDCl₃) δ −117.21.

### Example 23

A synthesis of

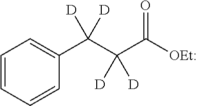

This example was performed as described in Example 1, except that ethyl 3-phenylpropiolate was used as the organic compound containing an ethylenic bond or acetylenic bond, obtaining the final deuterated product 2w, i.e. ethyl 3-phenylpropionate-α,β-D4, with a yield of 62%, and a deuterated ratio of 94% for the benzyl position and 94% for the ortho position of carbonyl.

The data of NMR analysis of product 2w was as follows:

¹H NMR (400 MHz, Chloroform-d) δ 7.30-7.26 (m, 2H), 7.21-7.18 (m, 3H), 4.12 (q, J=7.1 Hz, 2H), 2.92 (s, 0.13H, 94% D), 2.59 (s, 0.12H, 94% D), 1.23 (t, J=7.1 Hz, 3H);

¹³C NMR (100 MHz, CDCl₃) δ 172.9, 140.5, 128.5, 128.3, 126.2, 60.4, 14.2.

### Example 24

A synthesis of

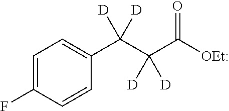

This example was performed as described in Example 1, except that ethyl 3-(4-fluorophenyl)-propiolate was used as the organic compound containing an ethylenic bond or acetylenic bond, obtaining the final deuterated product 2×, i.e. ethyl 3-(4-fluorophenyl)-propionate-α,β-D4, with a yield of 54%, and a deuterated ratio of 93% for the benzyl position and 94% for the ortho position of carbonyl.

The data of NMR analysis of product 2× was as follows:

¹H NMR (400 MHz, Chloroform-d) δ 7.15 (dd, J=8.5, 5.5 Hz, 2H), 6.96 (t, J=8.7 Hz, 2H), 4.12 (q, J=7.2 Hz, 2H), 2.89 (s, 0.15H, 93% D), 2.56 (s, 0.12H, 94% D), 1.23 (t, J=7.1 Hz, 2H);

¹³C NMR (100 MHz, Chloroform-d) δ 172.7, 161.5 (d, J=244.0 Hz), 136.1, 129.7 (d, J=7.8 Hz), 115.2 (d, J=21.2 Hz), 60.4, 14.2; 19F NMR (376 MHz, CDCl₃) δ −117.15.

### Example 25

A synthesis of

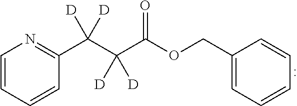 [SMILES: [2H]C([2H])(C(=O)OCc1ccccc1)C([2H])([2H])c1ccccn1]

This example was performed as described in Example 1, except that benzyl 3-(2-pyridyl)-propiolate was used as the organic compound containing an ethylenic bond or acetylenic bond, obtaining the final deuterated product 2y, i.e. benzyl 3-(2-pyridyl)-propionate-α,β-D4, with a yield of 58%, and a deuterated ratio of 94% for the benzyl position and 95% for the ortho position of carbonyl.

The data of NMR analysis of product 2y was as follows:

¹H NMR (400 MHz, Chloroform-d) δ 8.49 (d, J=5.5 Hz, 1H), 7.55 (td, J=7.7, 1.8 Hz, 1H), 7.36-7.29 (m, 5H), 7.14 (d, J=7.8 Hz, 1H), 7.10 (ddd, J=7.5, 4.9, 1.0 Hz, 1H), 5.11 (s, 2H), 3.09 (s, 0.12H, 94% D), 2.82 (s, 0.101H, 95% D);

¹³C NMR (100 MHz, CDCl₃) δ 172.9, 149.3, 136.4, 128.5, 128.5, 128.1, 127.6, 127.0, 123.0, 121.4, 66.2.

### Example 26

A synthesis of

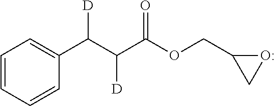

This example was performed as described in Example 1, except that oxiranylmethyl cinnamate was used as the organic compound containing an ethylenic bond or acetylenic bond, obtaining the final deuterated product 2z, i.e. oxiranylmethyl 3-phenylpropionate-α,β-D2, with a yield of 71%, and a deuterated ratio of 97% for the benzyl position and 95% for the ortho position of carbonyl.

The data of NMR analysis of product 2z was as follows:

¹H NMR (400 MHz, Chloroform-d) δ 7.31-7.27 (m, 2H), 7.21-7.18 (m, 3H), 4.39 (dd, J=12.3, 3.1 Hz, 1H), 3.92 (dd, J=12.3, 6.3 Hz, 1H), 3.18-3.14 (m, 1H), 2.95-2.93 (m, 1.03H, 97% D), 2.80 (t, J=4.5 Hz, 1H), 2.68-2.65 (m, 1.05H, 95% D), 2.59 (dd, J=4.9, 2.6 Hz, 1H);

¹³C NMR (100 MHz, CDCl₃) δ 172.5, 140.3, 128.5, 128.3, 126.3, 64.9, 49.3, 44.6, 35.3 (t, J=20.0 Hz), 30.5 (t, J=20.0 Hz).

### Example 27

A synthesis of

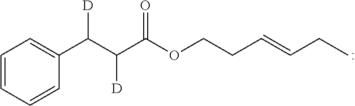 [SMILES: [2H]C(C(=O)OCC/C=C/CC)C([2H])c1ccccc1]

This example was performed as described in Example 1, except that n-hex-3-en-1-yl cinnamate was used as the organic compound containing an ethylenic bond or acetylenic bond, obtaining the final deuterated product 2aa, i.e. n-hex-3-en-1-yl 3-phenylpropionate-α,β-D2, with a yield of 70%, and a deuterated ratio of 96% for the benzyl position and 99% for the ortho position of carbonyl.

The data of NMR analysis of product 2aa was as follows:

¹H NMR (400 MHz, Chloroform-d) δ 7.33-7.29 (m, 2H), 7.24-7.22 (m, 3H), 5.60-5.51 (m, 1H), 5.40-5.31 (m, 1H), 4.11 (t, J=6.9 Hz, 2H), 2.98-2.94 (m, 1.01H, 99% D), 2.66-2.62 (m, 1.04H, 96% D), 2.32 (q, J=6.8, 6.3 Hz, 2H), 2.03 (p, J=8.1, 7.4 Hz, 2H), 0.99 (t, J=7.5 Hz, 3H);

¹³C NMR (100 MHz, CDCl₃) δ 172.9, 140.5, 135.1, 128.5, 128.3, 126.2, 124.0, 64.1, 35.6 (t, J=20.0 Hz), 31.9, 30.6 (t, J=20.0 Hz), 25.6, 13.7.

### Example 28

A synthesis of

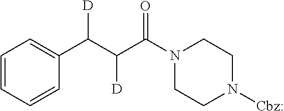

This example was performed as described in Example 1, except that 4-cinnamoyl-1-benzyloxypiperazine was used as the organic compound containing an ethylenic bond or acetylenic bond, obtaining the final deuterated product 2ab, i.e. 4-(3-phenylpropanoyl-α,β-D2)-1-benzyloxypiperazine, with a yield of 47%, and a deuterated ratio of 96% for the benzyl position and 94% for the ortho position of carbonyl.

The data of NMR analysis of product 2ab was as follows:

¹H NMR (400 MHz, Chloroform-d) δ 7.38-7.25 (m, 7H), 7.21-7.18 (m, 3H), 5.13 (s, 2H), 3.61-3.58 (m, 2H), 3.46-3.43 (m, 2H), 3.33 (s, 4H), 2.98-2.94 (m, 1.04H, 96% D), 2.62-2.59 (m, 1.06H, 94% D);

¹³C NMR (100 MHz, CDCl₃) δ 170.9, 155.1, 140.9, 136.4, 128.5, 128.4, 128.2, 128.0, 128.0, 126.3, 67.4, 45.3, 43.7, 41.3, 34.6 (t, J=20.0 Hz), 31.1 (t, J=20.0 Hz).

### Example 29

A synthesis of

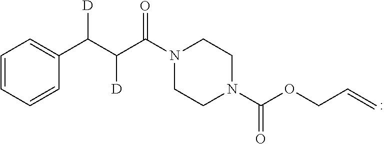 [SMILES: [2H]C(C(=O)N1CCN(C(=O)OCC=C)CC1)C([2H])c1ccccc1]

This example was performed as described in Example 1, except that 4-cinnamoyl-1-allyloxypiperazine was used as the organic compound containing an ethylenic bond or acetylenic bond, obtaining the final deuterated product 2ac, i.e. 4-(3-phenylpropanoyl-α,β-D2)-1-allyloxypiperazine, with a yield of 40%, and a deuterated ratio of 98% for the benzyl position and 97% for the ortho position of carbonyl.

The data of NMR analysis of product 2ac was as follows:

¹H NMR (400 MHz, Chloroform-d) δ 7.31-7.27 (m, 2H), 7.22-7.18 (m, 3H), 5.93 (ddt, J=16.3, 10.8, 5.6 Hz, 1H), 5.29 (d, J=17.2 Hz, 1H), 5.22 (d, J=10.4 Hz, 1H), 4.60 (d, J=5.5 Hz, 2H), 3.62-3.60 (m, 2H), 3.45-3.43 (m, 2H), 3.33 (s, 4H), 2.98-2.95 (m, 1.02H, 98% D), 2.64-2.60 (m, 1.03H, 97% D);

¹³C NMR (100 MHz, CDCl₃) δ 188.1, 170.9, 154.9, 140.9, 132.7, 128.6, 128.4, 126.3, 117.8, 66.3, 45.3, 43.6, 41.3, 34.6 (t, J=20.0 Hz), 31.1 (t, J=20.0 Hz).

### Example 30

A synthesis of

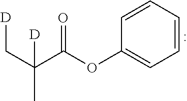

This example was performed as described in Example 1, except that phenyl α-methacrylate was used as the organic compound containing an ethylenic bond or acetylenic bond, obtaining the final deuterated product 2ad, i.e. phenyl 2-methacrylate-2,3-D2, with a yield of 69%, and a deuterated ratio of 98% for R position and 95% for ortho position.

The data of NMR analysis of product 2ad was as follows:

¹H NMR (400 MHz, Chloroform-d) δ 7.37 (t, J=7.9 Hz, 2H), 7.21 (t, J=7.4 Hz, 1H), 7.07 (d, J=7.7 Hz, 2H), 2.82-2.77 (m, 0.05H, 95% D), 1.31 (s, 3H), 1.29 (s, 2.02H, 98% D);

¹³C NMR (100 MHz, CDCl₃) δ 175.6, 150.9, 129.3, 125.6, 121.5, 33.8 (t, J=20.0 Hz), 18.8, 18.5 (t, J=20.0 Hz).

### Example 31

A synthesis of

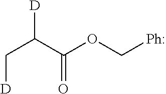

This example was performed as described in Example 1, except that benzyl acrylate was used as the organic compound containing an ethylenic bond or acetylenic bond, obtaining the final deuterated product 2ae, i.e. benzyl propionate-2,3-D2, with a yield of 38%, and a deuterated ratio of 93% for position 2 and 94% for position 3.

The data of NMR analysis of product 2ae was as follows:

¹H NMR (400 MHz, Chloroform-d) δ 7.37-7.32 (m, 5H), 5.12 (s, 2H), 2.40-2.36 (m, 1.07H, 93% D), 1.17-1.13 (m, 2.06H, 94% D);

¹³C NMR (100 MHz, CDCl₃) δ 174.3, 136.1, 128.5, 128.2, 66.1, 27.3 (t, J=20.0 Hz), 8.8 (t, J=20.0 Hz).

The description of the above embodiments is intended to understand the method of the present disclosure and its core idea. It should be pointed out that, for those of ordinary skill in the art, without departing from the principle of the present disclosure, several improvements and modifications can be made to the present disclosure, and these improvements and modifications also fall within the protection scope of the claims of the present disclosure. Many modifications to these embodiments will be apparent for those skilled in the art, and the general principles defined herein can be implemented in other embodiments without departing from the spirit or scope of the present disclosure. Therefore, the present disclosure should not be limited to the embodiments shown herein, but should be accorded the widest scope consistent with the principles and novel features disclosed herein.

1) A catalyst-free electrochemical deuteration method using deuterium oxide as a deuterium source, comprising,
adding an electrolyte, an organic compound containing an ethylenic bond or acetylenic bond, deuterium oxide, and an organic solvent into a reactor,
applying a direct current voltage of 4-8 V between electrodes of a carbon felt in an atmosphere of an inert gas for an electrolytic reaction, to obtain a product, and
purifying the product, to obtain a deuterated product;
wherein the organic compound containing an ethylenic bond or acetylenic bond is selected from the group consisting of olefin, alkyne, unsaturated ester, unsaturated amide and unsaturated carboxylic acid.

2) The catalyst-free electrochemical deuteration method using deuterium oxide as a deuterium source as claimed in claim 1, wherein the organic compound containing an ethylenic bond or acetylenic bond is selected from the group consisting of ethyl 3-phenylacrylate, butyl 3-phenylacrylate, 1-pentene-4-yl 3-phenylacrylate, cyclohexyl 3-phenylacrylate, tetrahydrofuran-3-yl 3-phenylacrylate, diethyl-phosphonomethyl 3-phenylacrylate, benzyl 3-phenylacrylate, phenyl 3-phenylacrylate, menthyl 3-phenylacrylate, 3-(3-phenylacrylyl) estrone, borneyl 3-phenylacrylate, pregnenolone 3-phenylacrylate, 3-(3-phenylacrylyl) estrone, and cholesteryl 3-phenylacrylate.

3) The catalyst-free electrochemical deuteration method using deuterium oxide as a deuterium source as claimed in claim 1, wherein the electrolyte is selected from the group consisting of tetrabutylammonium tetrafluoroborate and LiClO₄, and has a concentration of 0.02 mol/L.

4) The catalyst-free electrochemical deuteration method using deuterium oxide as a deuterium source as claimed in claim 1, wherein a molar ratio of deuterium oxide to the organic compound containing an ethylenic bond or acetylenic bond is in a range of (5-20):1.

5) The catalyst-free electrochemical deuteration method using deuterium oxide as a deuterium source as claimed in claim 1, wherein the organic solvent is selected from the group consisting of DMF and acetonitrile.

6) The catalyst-free electrochemical deuteration method using deuterium oxide as a deuterium source as claimed in claim 1, wherein the inert gas is selected from the group consisting of nitrogen and argon.

7) The catalyst-free electrochemical deuteration method using deuterium oxide as a deuterium source as claimed in claim 1, wherein purifying the product comprises steps:
extracting the product with ethyl acetate to obtain an organic phase, washing the organic phase with saturated salt water, then drying with anhydrous sodium sulfate, and filtering to obtain a filtrate;
drying the filtrate with a rotary evaporator, to obtain a sample;
subjecting the sample to a column chromatography by using a column chromatography technology, in which, 300-400 mesh silica gel is used as a stationary phase, and the sample is directly loaded on the silica gel, and eluted with a mixed solution of petroleum ether and ethyl acetate as an eluent, to obtain an eluate, which is detected by GC-MS;
collecting and concentrating the eluate containing a deuterated product.

8) The catalyst-free electrochemical deuteration method using deuterium oxide as a deuterium source as claimed in claim 1, wherein the electrolytic reaction is carried out for 2-10 h.

9) The catalyst-free electrochemical deuteration method using deuterium oxide as a deuterium source as claimed in claim 6, wherein purifying the product comprises steps:
extracting the product with ethyl acetate to obtain an organic phase, washing the organic phase with saturated salt water, then drying with anhydrous sodium sulfate, and filtering to obtain a filtrate;
drying the filtrate with a rotary evaporator, to obtain a sample;
subjecting the sample to a column chromatography by using a column chromatography technology, in which, 300-400 mesh silica gel is used as a stationary phase, and the sample is directly loaded on the silica gel, and eluted with a mixed solution of petroleum ether and ethyl acetate as an eluent, to obtain an eluate, which is detected by GC-MS;
collecting and concentrating the eluate containing a deuterated product.
